(19) United States
(12) Patent Application Publication
(10) Pub. No.: US 2008/0141731 A1
(43) Pub. Date: Jun. 19, 2008

(54) Rotation body control device and washing machine including the same

(75) Inventors: Suzuki Seiichiro, Osaka (JP); Kanazawa Naoki, Osaka (JP); Matsui Shoichi, Osaka (JP); Sato Sadayuki, Osaka (JP)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/000,084

(22) Filed: Dec. 7, 2007

(30) Foreign Application Priority Data
Dec. 18, 2006 (JP) 10-2006-339966
Jul. 2, 2007 (KR) 2007-66088

(51) Int. Cl. D06F 37/20; F16F 15/36

(52) U.S. Cl. 68/23.2; 74/572.4

(57) ABSTRACT

Disclosed herein are a rotation body control device capable of suppressing a vibration, and a washing machine including the same. The rotation body control device includes at least two balancing units each including an annular race and a plurality of rolling bodies seated in the race to be moved according to a rotation of the rotation body; a rotation number measuring unit measuring a number of rotations of the rotation body; a detecting unit detecting a rotation speed of the rotation body; an analysis unit analyzing a variation in the rotation speed detected by the detecting unit and calculating a weight of the imbalance occurring in the rotation body; and a control unit controlling the rotation of the rotation body according to the calculated weight of the imbalance by the analyzing unit.

### CROSS-REFERENCE TO RELATED APPLICATIONS

This application claims the benefit of Korean Patent Application No. 2007-66088, filed on Jul. 2, 2007 in the Korean Intellectual Property Office, the disclosure of which is incorporated herein by reference.

### BACKGROUND

1. Field

The present invention relates to a rotation body control device to control the operation of a rotation body, in which an eccentric state, that is, an imbalance, may occur at the time of rotation thereof, and a washing machine including the same.

2. Description of the Related Art

Examples of a rotation body, in which an imbalance occurs, include a spin basket of a washing machine. In a dehydrating process of a washing machine, laundry put in the spin basket is unevenly distributed in the inner circumference of the spin basket such that the imbalance occurs. In this state, when the spin basket is rotated at a high speed, a force is biased toward the rotation axis of the spin basket to generate large vibrations.

In order to prevent the vibrations due to such an imbalance, a washing machine including a race which is provided to be concentric with a spin basket and balancing units having a plurality of rolling bodies seated in the race together with oil is disclosed in Japanese Unexamined Patent Publication No. 10-43472.

In the washing machine disclosed in the above Publication, when the spin basket is rotated at a high speed, the rolling bodies are automatically moved in the race to prevent the force from being biased toward the rotation axis such that the imbalance is removed.

In addition, in order to remove imbalances which occur at both ends of the spin basket and to increase the number of rolling bodies, the washing machine includes a plurality of balancing units.

However, in the washing machine including the balancing units as described above, if the weight of the imbalance is larger than the total weight of the rolling bodies, the imbalance cannot be sufficiently removed even if the rolling bodies are located opposite the imbalance in the circumferential direction (opposite phase). Thus, vibrations will normally occur. The weight of the imbalance indicates an eccentric amount of the rotation body which occurs at the time of rotation.

Accordingly, it is necessary to measure the weight of the imbalance which occurs in the rotation body with high precision to control the rotation of the rotation body.

Meanwhile, in a rotation body which does not include a balancing unit, an imbalance is rotated by the rotation body and thus a variation in rotation speed occurs. Accordingly, it is possible to estimate the weight of the imbalance from the amplitude of the variation in speed.

However, when the plurality of balancing units is included as described above, the operation states of the rolling bodies seated in the plurality of balancing units are different from one another. Thus, since a variation in rotation speed becomes complicated, it is difficult to calculate the weight of the imbalance.

### SUMMARY

Therefore, it is an aspect to provide a rotation body control device capable of suppressing vibrations using a plurality of balancing units included in a rotation body, and a washing machine including the same.

Additional aspects and/or advantages will be set forth in part in the description which follows and, in part, will be obvious from the description, or may be learned by practice of the invention.

The above and/or other aspects can be achieved by the provision of a rotation body control device to control a rotation of a rotation body which is rotatably mounted about a rotation axis, the device including: at least two balancing units each including an annular race integrally formed with the rotation body and concentric with the rotation axis of the rotation body and a plurality of rolling bodies seated in the race to be moved according to the rotation of the rotation body; a rotation number measuring unit measuring a number of rotations of the rotation body; a detecting unit detecting a rotation speed of the rotation body; an analysis unit analyzing a variation in the rotation speed detected by the detecting unit and calculating a weight of an imbalance occurring in the rotation body; and a control unit controlling the rotation of the rotation body according to the calculated weight of the imbalance by the analyzing unit, wherein the analysis unit analyzes the variation in the rotation speed when the number of rotations of the rotation body is less than a number of rotations when a movement of the rolling bodies seated in all the balancing units is started or a number of rotations when a movement of the rolling bodies seated in another balancing unit excluding one balancing unit is started.

Since the rotation body control device having the above-described configuration includes the detecting unit which detects the rotation speed, the analysis unit which analyzes the variation in rotation speed with the number of rotations less than the number of rotations when the movement of the rolling bodies seated in all the balancing units is started or the number of rotations when the movement of the rolling bodies seated in the other balancing unit excluding one balancing unit is started and calculates the weight of the imbalance, and the control unit which controls the rotation body on the basis of the calculated result, it is possible to remove the imbalance by the balancing units with certainty and to suppress normal vibrations of the rotation body.

When the variation in the rotation speed is analyzed with the number of rotations less than the number of rotations when the movement of the rolling bodies seated in all the balancing units is started, it is possible to calculate the weight of the imbalance using the amplitude of the variation in rotation speed as described above.

When the variation in the rotation speed is analyzed with the number of rotations less than the number of rotations when the movement of the rolling bodies seated in the other balancing unit excluding one balancing unit is started, it is possible to calculate the weight of the imbalance, by detecting a bit signal of the rotation speed which is generated on the basis of the variation in relative position between the imbalance of the rotation body and the rolling bodies of one balancing unit and analyzing the bit signal.

According to the present embodiments, it is possible to provide a rotation body control device to calculate the weight of an imbalance and control a rotation body including a plurality of balancing units to suppress vibrations using the plurality of balancing units, and a washing machine including the same.

The foregoing and/or other aspects are achieved by providing a washing machine, including: a rotary tub; a rotation body rotatably installed in the rotary tub; at least two balancing devices integrally formed with the rotation body and including rolling bodies seated in the balancing devices; and a control unit controlling a rotation of the rotation body according to a calculated weight of an imbalance, the weight being calculated when a number of rotations of the rotation body is less than a number of rotations when a movement of the rolling bodies seated in at least one of the balancing devices is started.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a cross-sectional view showing a configuration of a washing machine according to a first embodiment;

FIG. 2 is a block diagram of the washing machine shown in FIG. 1;

FIG. 3 is a schematic view of a balancing device included in the washing machine shown in FIG. 1;

FIG. 4 is a view showing a variation in a rotation speed of a motor included in the washing machine shown in FIG. 1;

FIG. 5 is a flowchart illustrating a dehydrating process of the washing machine shown in FIG. 1;

FIG. 6 is a block diagram of a washing machine according to a second embodiment;

FIG. 7 is a view showing a bit signal of a rotation speed of a motor included in the washing machine shown in FIG. 6; and

FIG. 8 is a flowchart illustrating a dehydrating process of the washing machine shown in FIG. 6.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinafter, a washing machine according to a first embodiment will be described in detail with reference to the accompanying drawings.

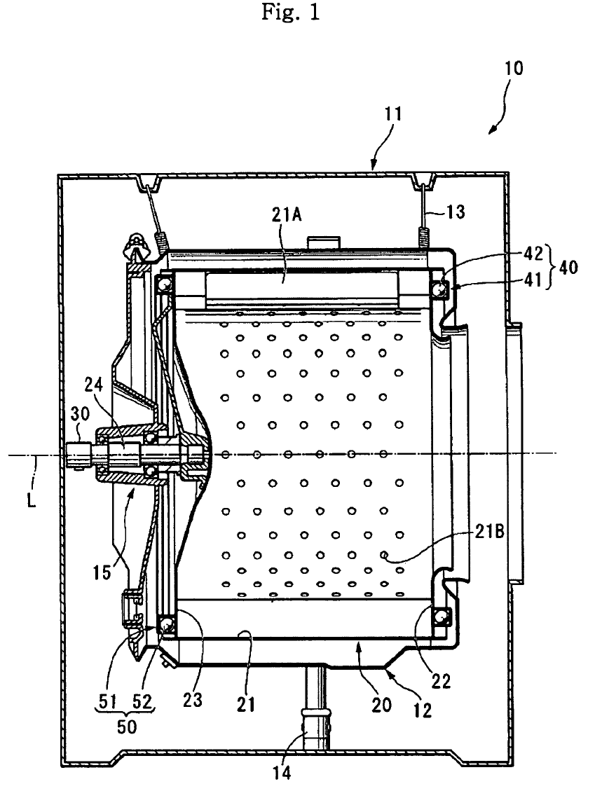

A washing machine 10 according to the present embodiment is a drum-shaped washing machine which can perform a washing process and a dehydrating process. As shown in FIG. 1, the washing machine 10 includes a casing 11, a tub 12 suspended in the casing 11, a spin basket 20 (rotation body) rotatably installed in the tub 12, and a motor 30 which rotates the spin basket 20 about a rotation axis L. The washing machine 10 further includes at least two balancing devices (balancing unit) to remove an imbalance which occurs in the spin basket 20. In the present embodiment, the washing machine 10 includes two balancing devices, that is, a first balancing device 40 and a second balancing device 50.

The tub 12 has a bottom and is cylindrically-shaped. The central axis of the tub 12 is substantially parallel to a horizontal plane and an opening is formed in the front side of the tub 12 (the right side of FIG. 1). The tub 12 is supported by a plurality of springs 13 or a damper 14 within the casing 11. A bearing 15 to support a main shaft 24 of the spin basket 20 is provided on the bottom of the tub 12.

The spin basket 20 provided in the tub 12 has a cylindrical side panel 21 and a front panel 22 and a back panel 23 which are respectively joined to the front and back sides of the side panel 21. An opening is formed in the front panel 22 so that laundry W can be put into or taken out of the spin basket 20 therethrough.

The main shaft 24 that rotates the spin basket 20 about the rotation axis L is provided at the back side (the left side of FIG. 1) of the back panel 23. The main shaft 24 is rotatably supported by the bearing 15 of the tub 12. The rotation axis L of the spin basket 20 and the central axis of the tub 12 coincide with each other.

A plurality of lifters 21A protruded toward an inner circumferential side of the spin basket 20 are provided on the side panel 21 in the circumferential direction with a predetermined gap interposed therebetween. The lifters 21A lift the laundry W therein according to the rotation of the spin basket 20.

A plurality of holes 21B to communicate an inside of the spin basket 20 with the tub 12 is formed in the side panel 21. Water, which flows into the tub 12, is fed into the spin basket 20 through the holes 21B at the time of the washing process and water, which flows out of the laundry W, flows to the tub 12 at the time of the dehydrating process.

The motor 30 is, for example, a DC motor to rotate the main shaft 24 about the rotation axis L.

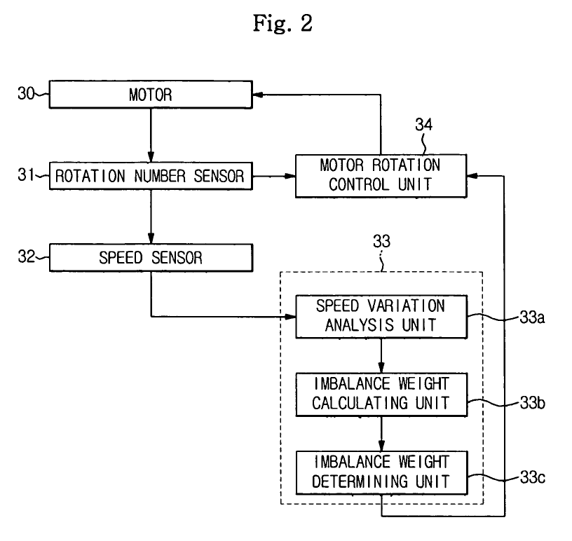

As shown in FIG. 2, the motor 30 communicates with a rotation number sensor 31 to measure the number of rotations of the motor 30 and a speed sensor 32 to measure the rotation speed ω of the motor 30. The operation of the motor 30 is controlled by a motor rotation control unit 34.

As the balancing device to remove the imbalance which occurs in the spin basket 20, the first balancing device 40 is provided on the front panel 22 of the spin basket 20 and the second balancing device 50 is provided on the back panel 23 of the spin basket 20.

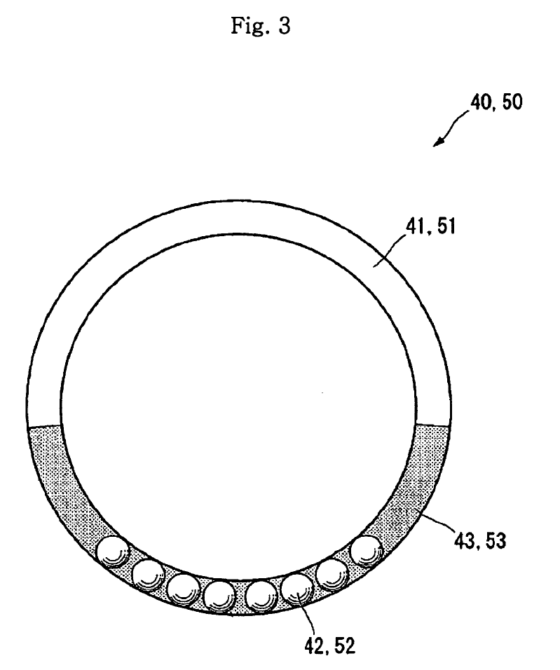

As shown in FIG. 3, the first balancing device 40 and the second balancing device 50 respectively include annular races 41 and 51 which are formed to be concentric with the rotation axis L of the spin basket 20 and a plurality of balls 42 and 52 which are seated in the races 41 and 51 together with oil 43 and 53. The plurality of balls 42 and 52 can be respectively moved in the races 41 and 51 according to the rotation of the spin basket 20.

Accordingly, when the number of rotations N of the spin basket 20 is equal to or greater than a predetermined number of rotations, the balls 42 and 52 respectively seated in the first balancing device 40 and the second balancing device 50 are respectively moved in the races 41 and 51. In the present embodiment, a number of rotations ξ1 when the movement of the balls 42 seated in the first balancing device 40 is started and a number of rotations ξ2 when the movement of the balls 52 seated in the second balancing device 50 is started are set to be different from each other.

In more detail, the viscosity of the oil 43 contained in the race 41 of the first balancing device 40 is set to be higher than that of the oil 53 contained in the race 51 of the second balancing device 50. Then, in the first balancing device 42, a friction force and a resistance force generated between the oil 43 and the balls 42 are increased to urge the movement of the balls 42. Accordingly, the number of rotations ξ1 when the movement of the balls 42 seated in the first balancing device 40 is started is set to be less than the number of rotations ξ2 when the movement of the balls 52 seated in the second balancing device 50 is started.

Next, the operations of the first balancing device 40 and the second balancing device 50 will be described. First, when laundry W is put into the spin basket 20 and the spin basket 20 is rotated, the laundry W sticks to a portion of the inner circumferential surface of the spin basket 20. Accordingly, an imbalance occurs in the spin basket 20. When the spin basket 20 is rotated with the number of rotations N larger than an inherent number of vibrations υ, the plurality of balls 42 and 52 are automatically moved in the first balancing device 40 and the second balancing device 50, thereby removing the imbalance.

Meanwhile, when the number of rotations N of the spin basket 20 is smaller than the inherent number of vibrations υ, the movement speed of the balls 42 and 52 becomes smaller than that of the imbalance (i.e., the rotation speed of the spin basket 20) due to the force of gravity, and thus the relative positions between the imbalance and the balls 42 and 52 in the circumferential direction vary. In the present embodiment, since the first balancing device 40 and the second balancing device 50 are included, the relative position between the imbalance and the balls 42 of the first balancing device 40 and the relative position between the imbalance and the balls 52 of the second balancing device 50 in the circumferential direction vary and thus have an influence on the rotation speed ω of the motor 30.

The torque τ of the motor 30 is expressed by Equation 1. In Equation 1, M_{unb} is the weight of the imbalance, M₁ is a total weight of the balls 42 of the first balancing device 40, M₂ is a total weight of the balls 52 of the second balancing device 50, ωₛ is the rotation speed of the spin basket 20, ω₁ is the rotation speed of the balls 42 of the first balancing device 40, ω₂ is the rotation speed of the balls 52 of the second balancing device 50, α, β and γ are initial phases, g is the acceleration of gravity, and K is a constant.

### Equation 1

τ=K*[M_{unb}g sin(ωₛt+α)+M₁g sin(ω₁t+β)+M₂g sin(ω₂t+γ)] (1)

Since the relative positions between the imbalance and the balls 42 and 52 of the first and second balancing devices 42 and 52 in the circumferential direction have an influence on the torque τ, a variation in the rotation speed ω of the motor 30 becomes complicated.

In the number of rotations when the balls 42 and 52 of the first and second balancing devices 40 and 50 are not moved, since the movement of the balls 42 of the first balancing device 40 and the movement of the balls 52 of the second balancing device 50 do not need to be considered in Equation 1, the torque τ can be expressed by Equation 2.

### Equation 2

τ=K*[M_{unb}g sin(ωₛt+α)] (2)

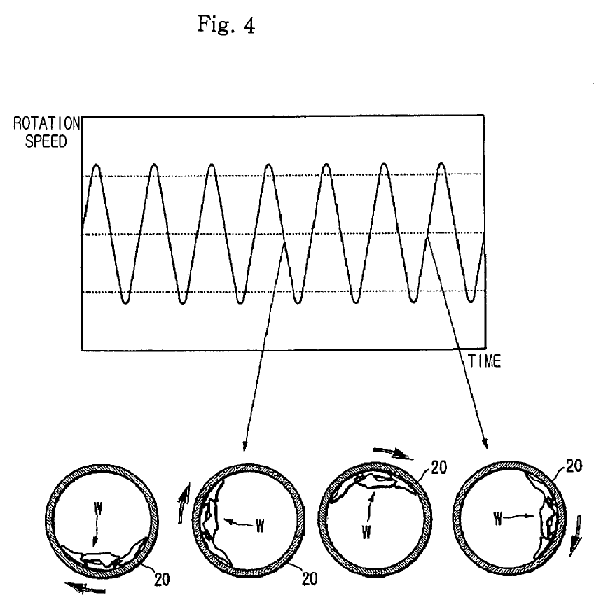

That is, the torque τ varies according to only the imbalance and thus the rotation speed ω of the motor 30 also varies. A relationship between the position of the imbalance in the circumferential direction and the variation in rotation speed ω of the motor 30 is shown in FIG. 4. When the imbalance is moved upward against the force of gravity, the rotation speed ω is decreased, and when the imbalance is moved downward by the force of gravity, the rotation speed ω is increased. As expressed by Equation 2, since the amplitude of the torque τ is proportional to the weight of the imbalance, it is possible to calculate the weight of the imbalance using the amplitude Δω of the rotation speed ω.

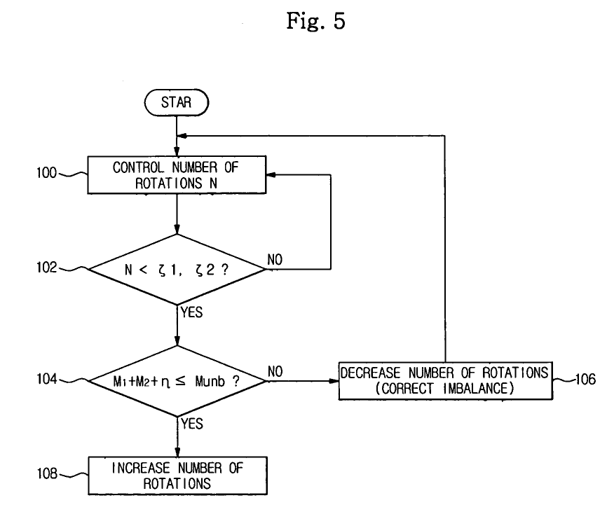

In the present embodiment, as shown in FIGS. 2 and 5, the number of rotations N of the motor 30 is measured by the rotation number sensor 31 and controlled at operation 100, and it is determined whether the number of rotations N of the motor 30 is less than the number of rotations ξ1 when the movement of the balls 42 seated in the first balancing device 40 is started and the number of rotations ξ2 when the movement of the balls 52 seated in the second balancing device 50 is started (N<ξ1 and N<ξ2) at operation 102. At this time, the rotation speed ω of the motor 30 is measured by the speed sensor 32 (detecting unit) to measure the variation Δω in the rotation speed. In an analysis unit 33, a speed variation analysis unit 33a analyzes the variation Δω in the rotation speed and an imbalance weight calculating unit 33b calculates the weight of the imbalance. An imbalance weight determining unit 33c compares the weight of the imbalance with the total weight of the balls 42 and 52. If the number of rotations N of the motor 30 is greater than or equal to the number of rotations ξ1 when the movement of the balls 42 seated in the first balancing device 40 is started and the number of rotations ξ2 when the movement of the balls 52 seated in the second balancing device 50 is started, the procedure returns to operation 100 and the number of rotations N is continuously controlled.

If the number of rotations N of the motor 30 is less than the number of rotations ξ1 when the movement of the balls 42 seated in the first balancing device 40 is started and the number of rotations ξ2 when the movement of the balls 52 seated in the second balancing device 50 is started, and if the weight of the imbalance is larger than the total weight of the balls 42 and 52 by at least a predetermined amount η at operation 104, the motor rotation control unit 34 decreases the number of rotations N of the spin basket 20 at operation 106. The procedure then returns to operation 200. Accordingly, the laundry W which sticks to the portion of the inner circumferential surface of the spin basket 20 is taken off to correct the imbalance. If the weight of the imbalance is less than or equal to the total weight of the balls 42 and 52 and the predetermined amount η, the motor rotation control unit 34 increases the number of rotations N of the spin basket 20 at operation 108.

The washing machine 10 having the above-described configuration includes the speed sensor 32 to detect the rotation speed ω of the motor 30, the speed variation analysis unit 33a to analyze the variation in rotation speed ω₁ the imbalance weight calculating unit 33b, and the imbalance weight determining unit 33c to compare the weight of the imbalance with the total weight of the balls 42 and 52. Since the motor rotation control unit 34 temporarily decreases the number of rotations N of the spin basket 20 to correct the imbalance if the weight of the imbalance is larger than the total weight of the balls 42 and 52 by at least the predetermined amount η, it is possible to remove the imbalance by the first and second balancing devices 40 and 50 with certainty. Accordingly, it is possible to prevent a normal vibration in the dehydrating process with certainty.

In the number of rotations which is less than the number of rotations ξ1 when the movement of the balls 42 seated in the first balancing device 40 is started and the number of rotations ξ2 when the movement of the balls 52 seated in the second balancing device 50 is started, since the variation in a rotation speed of the motor 30 is analyzed, it is possible to calculate the weight of the imbalance which occurs in the spin basket 20 with certainty.

Since the first balancing device 40 is provided on the front panel 22 of the spin basket 20 and the second balancing device 50 is provided on the back panel 23, the imbalance can be efficiently removed even when the imbalance occurs at the front side and the back side of the spin basket 20.

Next, a washing machine according to a second embodiment will be described. The same elements as the first embodiment are represented by the same reference numerals and thus the detailed description thereof will be omitted.

In the present embodiment, a gap between the race 41 and the balls 42 in the first balancing device 40 is smaller than a gap between the race 51 and the balls 52 in the second balancing device 50. Then, a friction force and a resistance force generated between the oil 43 and the balls 42 in the first balancing device 40 are increased to urge the movement of the balls 42. In the present embodiment, the number of rotations ξ1 when the movement of the balls 42 seated in the first balancing device 40 is started is set to be less than the number of rotations ξ2 when the movement of the balls 52 seated in the second balancing device 50 is started.

In the number of rotations N, in which only the balls 42 of the first balancing device 40 start to be moved and the balls 52 of the second balancing device 50 are not moved, that is, ξ1≦N<ξ2, since the movement of the balls 52 of the second balancing device 50 does not need to be considered in Equation 1, the torque τ can be expressed by Equation 3.

### Equation 3

τ=K*[M_{unb}g sin(ωₛt+α)+M₁g sin(ω₁t+α)] (3)

That is, the torque τ varies according to the relative position between the imbalance and the balls 42 of the first balancing device 40. Accordingly, the amplitude Δω of the rotation speed ω of the motor 30 periodically varies and thus a bit signal B is generated.

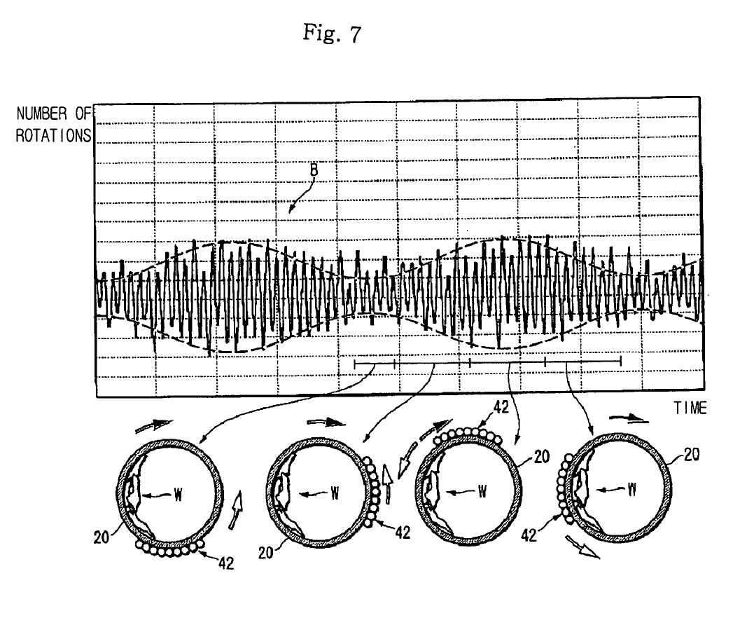

A relationship between the relative position between the imbalance and the balls 42 in the circumferential direction and the bit signal B is shown in FIG. 7. When the imbalance and the balls 42 are arranged in opposite phase to each other in the circumferential direction, the vibration is suppressed. Thus, the amplitude of the bit signal B (the amplitude Δω of the rotation speed ω of the motor 30) becomes minimized. In contrast, when the imbalance and the balls 42 are arranged in phase with each other in the circumferential direction, a large force is applied to the rotation axis L and thus the vibration is increased. Accordingly, the amplitude of the bit signal B (the amplitude Δω of the rotation speed ω of the motor 30) becomes maximized.

Subsequently, a method of calculating the weight of the imbalance from the bit signal B will be described. The rotation speed ω of the motor 30 is expressed by Equation 4. In Equation 4, M_{unb} is the weight of the imbalance, M₁ is the total weight of the balls 42 of the first balancing device 40, ωₛ is the rotation speed of the spin basket 20, ω₁ is the rotation speed of the balls 42, α and β are initial phases, J is the total amount of inertia, r is the radius of rotation, g is the acceleration of gravity, and τ is the torque of the motor 30.

$$\begin{matrix}\text{Equation 4} & \\ J \cdot \frac{d ω}{d t} = τ + {M}_{unb} \cdot g \cdot sin ( {ω}_{s} t + α ) + {M}_{1} \cdot g \cdot sin ( {ω}_{1} t + β ) & ( 4 )\end{matrix}$$

As described above, the amplitude Δω of the speed ω of the motor 30 becomes maximized if the imbalance and the balls 24 are arranged in phase with each other and becomes minimized if the imbalance and the balls 24 are arranged in opposite phase to each other. Accordingly, if Equation 4 is specified by the maximum and the minimum, the following equations are obtained.

### Equation 5

In-phase: Δωmax=k2×(Munb+M1)

### Equation 6

Opposite phase: Δωₘᵢₙ=K2×|M_{unb}−M₁|

From Equations 5 and 6, the weight M_{unb} of the imbalance is expressed as follows. Here, k1=½k2.

### Equation 7

M_{unb}>M₁:M_{unb}=k1×(Δωₘₐₓ+Δωₘᵢₙ)

### Equation 8

M_{unb}<M₁:M_{unb}=k1×(Δωₘₐₓ−Δωₘᵢₙ)

By Equations 7 and 8, it is possible to calculate the weight of the imbalance using the bit signal B due to the rotation speed ω of the motor 30.

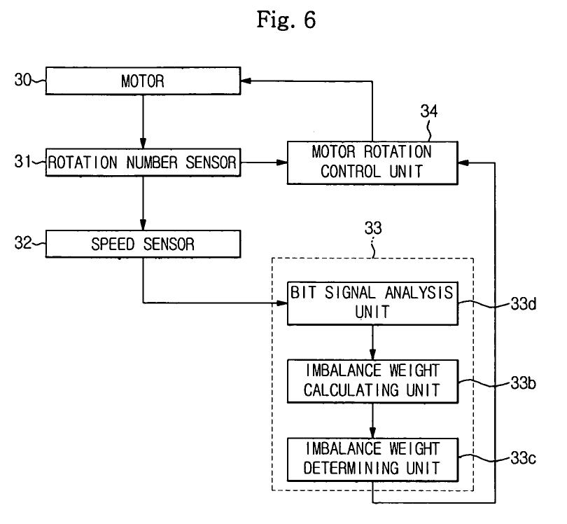

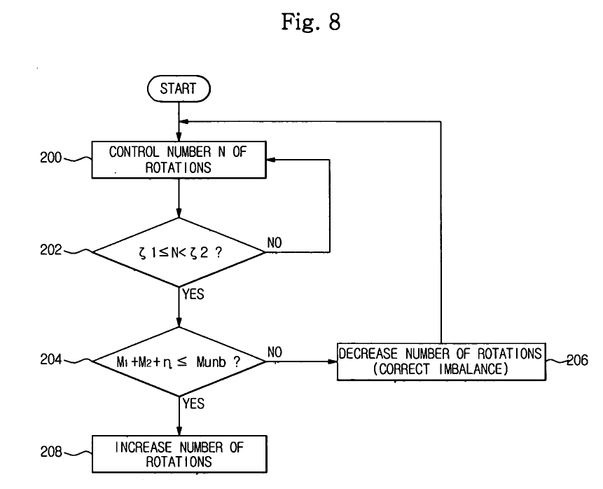

In the present embodiment, as shown in FIGS. 6 and 8, the number of rotations N of the motor 30 is measured by the rotation number sensor 31 and controlled at operation 200, and it is determined whether the number of rotations N of the motor 30 is equal to or greater than the number of rotations ξ1 when the movement of the balls 42 seated in the first balancing device 40 is started and is less than the number of rotations ξ2 when the movement of the balls 52 seated in the second balancing device 50 is started (ξ1≦N<ξ2) at operation 202. In this state, a variation (bit signal B) in amplitude Δω of the rotation speed ω of the motor 30 is measured by the speed sensor 32 (detecting unit). In the analysis unit 33, a bit signal analysis unit 33d analyzes the bit signal B and the imbalance weight calculation unit 33b calculates the weight of the imbalance. The imbalance weight determination unit 33c compares the weight of the imbalance with the total weight of the balls 42 and 52. If the number of rotations N of the motor 30 is less than the number of rotations ξ1 when the movement of the balls 42 seated in the first balancing device 40 is started and/or the number of rotations N of the motor 30 is greater than or equal to the number of rotations ξ2 when the movement of the balls 52 seated in the second balancing device 50 is started, the procedure returns to operation 200 and the number of rotations N is continuously controlled.

If the number of rotations N of the motor 30 is equal to or greater than the number of rotations ξ1 when the movement of the balls 42 seated in the first balancing device 40 is started and is less than the number of rotations ξ2 when the movement of the balls 52 seated in the second balancing device 50 is started, and if the weight of the imbalance is larger than the total weight of the balls 42 and 52 by at least a predetermined amount η at operation 204, the motor rotation control unit 34 decreases the number of rotations N of the spin basket 20 at operation 206. Accordingly, the laundry W which sticks to the portion of the inner circumferential surface of the spin basket 20 is taken off so as to correct the imbalance. The procedure then returns to operation 200. If the weight of the imbalance is less than or equal to the total weight of the balls 42 and 52 and the predetermined amount η, the motor rotation control unit 34 increases the number of rotations N of the spin basket 20 at operation 208.

The washing machine 10 having the above-described configuration includes the speed sensor 32 to detect the rotation speed ω of the motor 30, the bit signal analysis unit 33d to analyze the bit signal B of the rotation speed ω, the imbalance weight calculation unit 33b to calculate the weight of the imbalance from the analyzed result, and the imbalance weight determination unit 33c to compare the weight of the imbalance with the total weight of the balls 42 and 52. Since the motor rotation control unit 34 temporarily decreases the number of rotations N of the spin basket 20 to correct the imbalance if the weight of the imbalance is larger than the total weight of the balls 42 and 52 by at least the predetermined amount η, it is possible to suppress the vibration of the spin basket 20 by the balancing device 40 with certainty.

In the present embodiment, since the gap between the race 41 and the balls 42 in the first balancing device 40 is smaller than the gap between the race 51 and the balls 52 in the second balancing device 50 and the number of rotations ξ1 when the movement of the balls 42 seated in the first balancing device 40 is started and the number of rotations ξ2 when the movement of the balls 52 seated in the second balancing device 50 is started are set to be different from each other, it is possible to increase a difference between the number of rotations ξ1 when the movement of the balls 42 seated in the first balancing device 40 is started and the number of rotations ξ2 when the movement of the balls 52 seated in the second balancing device 50 is started, by adjusting a difference between the gaps.

Although the washing machine is described as the embodiments, the present embodiments are not limited to this and may be variously changed without departing the technical spirit of the present embodiments.

An apparatus including the rotation body control device is not limited to the washing machine and other industrial apparatuses or other electronic appliances such as a centrifugal separator may be used.

Although the number of rotations ξ1 when the movement of the balls seated in the first balancing device is started and the number of rotations ξ2 when the movement of the balls seated in the second balancing device is started are set to be different from each other in the first embodiment, the numbers of rotations ξ1 and ξ2 may be equal to each other if the rotation speed is analyzed when the number of rotations N of the spin basket satisfies N<ξ1 and N<ξ2 like the first embodiment.

Although the number of rotations ξ1 when the movement of the balls seated in the first balancing device is started and the number of rotations ξ2 when the movement of the balls seated in the second balancing device is started are set to be different from each other by changing the viscosity of the oil in the first embodiment and by adjusting the gap between the race and the balls in the second embodiment, other methods may be used. The numbers of rotations ξ1 and ξ2 may be adjusted by changing the weight per ball of the balancing device to vary a force of gravity applied to the ball. Alternatively, the roughness of the inner surface of the race or the roughness of the surface of the ball may be changed.

Although the two balancing devices (units) are included in the present embodiments, at least three balancing devices may be included. In this case, the rotation speed of the motor is analyzed with the number of rotations when the movement of the balls seated in all the balancing devices is started or the number of rotations when the movement of the balls seated in the other balancing devices excluding one balancing device is started.

Although oil is contained in the race of the balancing device, the present embodiments are not limited to oil, and other fluids such as water or air may be contained.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A rotation body control device to control rotation of a rotation body which is rotatably mounted about a rotation axis, the device comprising:
at least two balancing units each including an annular race integrally formed with the rotation body and concentric with the rotation axis of the rotation body and a plurality of rolling bodies seated in the race to be moved according to the rotation of the rotation body;
a rotation number measuring unit measuring a number of rotations of the rotation body;
a detecting unit detecting a rotation speed of the rotation body;
an analysis unit analyzing a variation in the rotation speed detected by the detecting unit and calculating a weight of an imbalance occurring in the rotation body; and
a control unit controlling the rotation of the rotation body according to the calculated weight of the imbalance by the analyzing unit,
wherein the analysis unit analyzes the variation in the rotation speed when the number of rotations of the rotation body is less than a number of rotations when a movement of the rolling bodies seated in all the balancing units is started or a number of rotations when a movement of the rolling bodies seated in another balancing unit excluding one balancing unit is started.

2. The device according to claim 1, wherein, in the at least two balancing units, the number of rotations of the rotation body when the movement of the rolling bodies seated in one balancing unit is started is set to be less than the number of rotations of the rotation body when the movement of the rolling bodies seated in the other balancing unit is started.

3. The device according to claim 1 or 2, wherein:
the analysis unit calculates the weight of the imbalance occurring in the rotation body based on the variation in the rotation speed detected by the detecting unit, and compares the weight of the imbalance with a total weight of the rolling bodies, and
the control unit temporarily decreases the number of rotations of the rotation body when the weight of the imbalance is larger than the total weight of the rolling bodies by a predetermined amount.

4. A washing machine comprising the device according to claim 1 or 2, wherein the rotation body is a spin basket having an inner space to contain laundry therein and being rotatably mounted about the rotation axis.

5. The washing machine according to claim 4, wherein:
the analysis unit calculates the weight of the imbalance occurring in the rotation body based on the variation in the rotation speed detected by the detecting unit, and compares the weight of the imbalance with a total weight of the rolling bodies, and
the control unit temporarily decreases the number of rotations of the rotation body when the weight of the imbalance is larger than the total weight of the rolling bodies by a predetermined amount.

6. A washing machine, comprising:
a rotary tub;
a rotation body rotatably installed in the rotary tub;
at least two balancing devices integrally formed with the rotation body and including rolling bodies seated in the balancing devices; and
a control unit controlling a rotation of the rotation body according to a calculated weight of an imbalance, the weight being calculated when a number of rotations of the rotation body is less than a number of rotations when a movement of the rolling bodies seated in at least one of the balancing devices is started.

7. The washing machine according to claim 6, further comprising an analysis unit analyzing a variation in a rotation speed of the rotation body, wherein the control unit calculates the weight of the imbalance based on the variation in the rotation speed of the rotation body.

8. The washing machine according to claim 7, wherein the control unit decreases the number of rotations of the rotation body when the weight of the imbalance is greater than or equal to a total weight of the rolling bodies of the balancing devices by a predetermined amount, and increases the number of rotations of the rotation body when the weight of the imbalance is not greater than or equal to the total weight of the rolling bodies of the balancing devices by the predetermined amount.
